(19) United States
(12) Patent Application Publication
(10) Pub. No.: US 2026/0359426 A1
(43) Pub. Date: Nov. 12, 2026

(54) YARA RULES AUTOMATIVE GENERATION IN AUTOMATIVE

(71) Applicant: Red Hat, Inc., Raleigh, CA (US)

(72) Inventors: Andrea Cosentino, Milan (IT); Paolo Antinori, Milan (IT)

(21) Appl. No.: 19/204,340

(22) Filed: May 9, 2025

(51) Int. Cl. G06F 21/55

(52) U.S. Cl. CPC G06F 21/55; G06F 2221/034

(57) ABSTRACT

A system and method of an automotive malware diagnosis (AMD) system that detects and mitigates the spread of malware in connected vehicle networks. The method includes receiving, from a first vehicle in a first geographic zone, a message indicating that a pattern-matching rule has identified a type of malware on the first vehicle and a first neighboring vehicle communicatively coupled to the first vehicle and within the first geographic zone. The method includes generating a remedy to protect vehicles from being infected with the type of malware. The method includes sending the remedy to a second vehicle in a second geographic zone to cause the second vehicle to implement the remedy.

### TECHNICAL FIELD

The present disclosure relates to data processing, and more particularly, to systems and methods of an automotive malware diagnosis (AMD) system that detects and mitigates the spread of malware in vehicle-to-vehicle networks.

### BACKGROUND

Malware is malicious software designed to disrupt, damage, or gain unauthorized access to computer systems. As vehicles become more connected and reliant on software, malware poses a serious threat to automotive systems, potentially compromising safety and functionality. Hackers can exploit vulnerabilities in car infotainment systems, navigation systems, or even engine control units, leading to unauthorized remote access or system failures. This growing risk highlights the need for strong cybersecurity measures in modern vehicles to protect both driver safety and vehicle integrity.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram depicting an example environment for detecting and mitigating the spread of malware in vehicle-to-vehicle networks, according to some embodiments;

FIG. 2A is a block diagram depicting an example of the automotive malware diagnosis (AMD) system of the environment in FIG. 1, according to some embodiments;

FIG. 2B is a block diagram depicting an example of the electronic control unit in FIG. 1, according to some embodiments;

FIG. 2C is a block diagram depicting an example environment for using the AMD system in FIG. 1, according to some embodiments;

FIG. 3 is a flow diagram depicting a method of detecting and mitigating the spread of malware in vehicle-to-vehicle networks, according to some embodiments; and

FIG. 4 is a block diagram of an example computing device that may perform one or more of the operations described herein, in accordance with some embodiments.

### DETAILED DESCRIPTION

The growing prevalence of malware poses a significant threat within the broader security ecosystem. In the automotive sector, malware presents risks not only at the manufacturers' infrastructure level but also directly within vehicles themselves. As cars and the industry as a whole rapidly shift toward a software-driven model, the attack surface for cyber threats continues to expand. With this progression, the frequency and sophistication of malicious activity are expected to increase.

To address this issue, manufacturers and cybersecurity experts must implement robust security measures at every stage of automotive software development and deployment. Solutions include integrating advanced encryption techniques, real-time threat detection systems, and secure firmware updates to safeguard vehicles from cyberattacks. Additionally, collaboration between automotive companies, cybersecurity firms, and regulatory bodies is essential in developing standardized security protocols that proactively mitigate risks.

However, these solutions have not been implemented rapidly enough to prevent malware from spreading across vehicle-to-vehicle (V2V) networks. The interconnected nature of modern vehicles means that a single infected car can propagate vulnerabilities to others, increasing the potential scale of cyberattacks. Without faster adoption of stringent security protocols, the risk of widespread vehicle system compromises will continue to grow, posing serious safety concerns for both manufacturers and consumers. Thus, there is a long-felt but unsolved need for a solution for efficiently detecting and mitigating the spread of malware in vehicle-to-vehicle (V2V) networks.

Aspects of the present disclosure address the above-noted and other deficiencies by providing an automotive malware diagnosis (AMD) system that detects and mitigates the spread of malware in V2V networks. The ADM system introduces a mechanism for detecting, mitigating, and removing malware in the context of V2V networks. In that idea, the ADM system is able to identify the original file and infected vehicle that started the spread of the malware across the V2V network. The ADM system improves the knowledge base of the vehicle manufacturers by generating a YARA rule to recognize that particular malware on other vehicles of the same manufacturer or other manufacturers. YARA is an open-source and multi-platform tool that provides a mechanism to exploit code similarities between malware samples within a family.

The vehicle will be responsible for distributing the YARA rule to all the nearby vehicles. Assuming the attack has a geographical factor in its characteristics, many of the receiving vehicle will recognize the ransomware. Based on the answers the original discovering vehicle will receive from nearby vehicles, the YARA rule will be notified and sent to the AMD system (with its metadata), like a managed online service owned by car manufacturers or third party vendors. This rule may be written into a database, maintaining all the YARA rules for the particular manufacturer and each of the vehicles in the manufacturer’s fleet will receive the YARA rule file when connectivity is available.

The original discovering vehicle could also estimate the power of the malware and expect a certain number of answers from nearby based on this estimation. This could lead to faster external communication to the manufacturing infrastructure. Every car will then be able to recognize the malware. In other words, even if one of the vehicles will be affected, the ADM system can immediately protect the other vehicles in the fleet by propagating the YARA Rules generated by a vehicles to the other vehicles.

In an illustrative embodiment, an AMD system that that detects and mitigates the spread of malware in connected vehicle networks. The AMD receives, from a first vehicle (e.g., automobile, boat, airplane) in a first geographic zone, a message indicating that a pattern-matching rule has identified a type of malware on the first vehicle and a first neighboring vehicle communicatively coupled to the first vehicle and within the first geographic zone. The AMD generates a remedy to protect vehicles from being infected with the type of malware. The AMD protects a second vehicle in a second geographic zone from being infected with the type of malware by sending the remedy to the second vehicle to cause the second vehicle to implement the remedy.

Although embodiments of the AMD system are described with respect to Yet Another Recursive Acronym (YARA) rules, any of the embodiments may manage and process any other type of pattern-matching rules including, for example, a Sigma Rule, or a Suricata Rule, a Claim Antivirus (ClamAV) Signature, or Open Indicators of Compromise (OpenIOC) Rules.

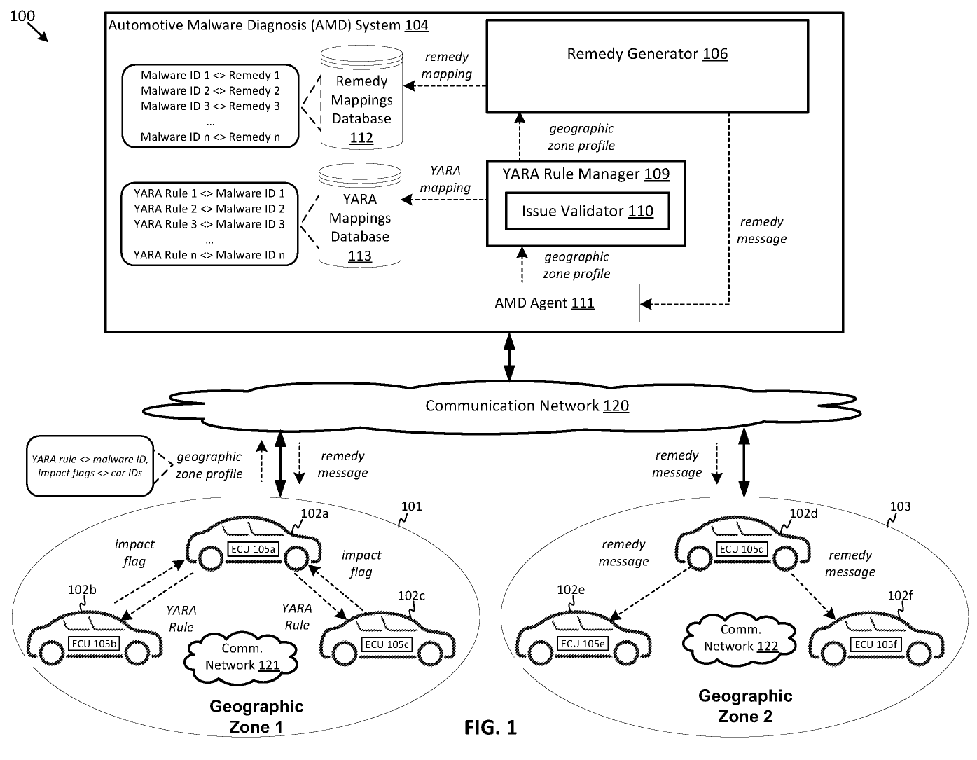

FIG. 1 is a block diagram depicting an example environment for detecting and mitigating the spread of malware in vehicle-to-vehicle networks, according to some embodiments. Environment 100 includes a first group of vehicles 102 (e.g., vehicles 102a-c) that are positioned within geographic zone 101. Vehicle 102a is communicably coupled to vehicles 102b and 102c via a communication network 121. Environment 100 includes a second group of vehicles 102 (e.g., vehicles 102d-f) that are positioned within geographic zone 103. Vehicle 102d is communicably coupled to vehicles 102e and 102f via a communication network 122. Environment 100 also includes AMD 104, which is communicably coupled to vehicle 102a and 102d via a communication network 120. A vehicle may include, for example, a land vehicle (e.g., automobiles), a water vehicle (e.g., boat), an air vehicle (e.g., airplane).

Each vehicle 102 includes an engine control unit (ECU) 105 that includes hardware (e.g., memory, processor, storage) and software (e.g., operating system, applications) for monitoring and controlling various aspects of the engine’s performance, such as the fuel injection, air-to-fuel ratio, ignition timing, emissions, brakes, steering, safety features, and the like. The ECU 105 also controls other non-critical portions of the vehicle, such as an infotainment system that includes a sound system; navigation system; touchscreen system; a heating, ventilation, and air conditioning (HVAC) system, and the like. As shown in FIG. 1, vehicle 102a includes ECU 105a, vehicle 102b includes ECU 105b, vehicle 102c includes ECU 105c, vehicle 102d includes ECU 105d, vehicle 102e includes ECU 105e, and vehicle 102f includes ECU 105f.

The AMD system 104 includes an AMD agent 111 configured to receive geographic profiles (e.g., messages) from vehicles 102a and forward the geographic profiles to other components of AMD system 104. The AMD system 104 includes a YARA rule manager 109 and a remedy generator 106. The YARA rule manager 109 may be configured to generate a YARA mapping that associates (e.g., links) the YARA rule with the malware ID and store the YARA mapping in one or more databases. For example, the YARA rule manager 109 may generate the YARA mapping by creating a schema (e.g., a table) that associates the YARA rule with the malware ID. The YARA rule manager 109 may repeat this process for each message it receives from any of the vehicles 102 in either of the geographic zones 101, 103.

The YARA rule manager 109 includes an issue validator 110 configured to determine whether the type of malware indicated by a YARA rule is more of a local issue (e.g., infecting 1 vehicle) or a universal issue (e.g., infecting many vehicles). If the malware is a universal issue, then the YARA rule manager 109 may determine to forward the geographic profile to the remedy generator 106, which is configured to generate a remedy for the malware. Otherwise, the YARA rule manager 109 may decide to not forward the geographic profile to the remedy generator 106 if the malware is a local issue.

The AMD system 104 includes a plurality of databases that are configured to store different datasets. Specifically, the AMD system 104 includes a YARA mappings database 113 that is configured to store a mapping between a plurality of YARA rules and a plurality of malware identifiers (ID) (e.g., malware name, hash value). For example, as shown in FIG. 1, YARA rule 1 is mapped to malware ID 1, YARA rule 2 is mapped to malware ID 2, YARA rule 3 is mapped to malware ID 3, and so on. A malware (short for malicious software) is any software designed to disrupt, damage, or gain unauthorized access to a computer system or network. It can steal data, spy on users, or interfere with normal operations. A malware may include, for example, a virus, a worm, a trojan horse, a spyware, a ransomware, an adware, a rootkit.

The AMD system 104 also includes a remedy mappings database 112 that is configured to store a mapping between a plurality of malware IDs (respectively corresponding to a plurality of malware) and a plurality of remedies to the malware. For example, as shown in FIG. 1, malware ID 1 is mapped to remedy 1, malware ID 2 is mapped to remedy 2, malware ID 3 is mapped to remedy 3, and so on.

Although FIG. 1 shows that the AMD system 104 stores different dataset in databases, in some embodiments, the AMD system 104 may store any of these datasets in a local memory of the AMD system 104 to reduce the time to retrieve the datasets. Thus, as used herein, a dataset may be a collection of data that is organized in a structured format (e.g., in rows and columns) or in an unstructured format that does not have a predefined model or organization.

In some embodiments, each of the components (e.g., AMD agent 111, remedy generator 106, YARA rule manager 109) of the AMD system 104 may be housed into a single computing device (e.g., a server, a laptop, a desktop, a host device, etc.). However, in other embodiments, some or all of the components of the AMD system 104 may be included in separate computing device and/or database that are geographically/physically separate from one another, but communicatively coupled via the communication network 120. Similarly, each of the databases (e.g., remedy mappings database 112, YARA mappings database 113) may correspond to its own separate database that is geographically/physically separate from the servers and other databases, but communicatively coupled via the communication network 120.

Communication networks 120-122 may each be a public network (e.g., the internet), a private network (e.g., a local area network (LAN) or wide area network (WAN), or a combination thereof. In one embodiment, the communication network 120-122 may include a wired or a wireless infrastructure, which may be provided by one or more wireless communications systems, such as Wi-Fi® connectivity to the communication networks 120-122 and/or a wireless carrier system that can be implemented using various data processing equipment, communication towers (e.g., cell towers), etc. The communication networks 120-122 may carry communications (e.g., data, message, packets, frames, etc.) between any other the computing device.

The AMD system 104 and ECU 105 may each be any suitable type of computing device or machine that has a processing device, for example, a server computer (e.g., an application server, a catalog server, a communications server, a computing server, a database server, a file server, a game server, a mail server, a media server, a proxy server, a virtual server, a web server), a desktop computer, a laptop computer, a tablet computer, a mobile device, a smartphone, a set-top box, a graphics processing unit (GPU), etc. In some examples, a computing device may include a single machine or may include multiple interconnected machines (e.g., multiple servers configured in a cluster).

A computing device may be one or more virtual environments. In one embodiment, a virtual environment may be a virtual machine (VM) that may execute on a hypervisor which executes on top of an operating system (OS) for a computing device. The hypervisor may manage system sources (including access to hardware devices, such as processing devices, memories, storage devices). The hypervisor may also emulate the hardware (or other physical resources) which may be used by the VMs to execute software/applications. In another embodiment, a virtual environment may be a container that may execute on a container engine which executes on top of the OS for a computing device. For example, a container engine may allow different containers to share the OS of a computing device (e.g., the OS kernel, binaries, libraries, etc.). A computing device may use the same type or different types of virtual environments. For example, all of the computing devices may be VMs. In another example, all of the computing devices may be containers. In a further example, some of the computing devices may be VMs, other computing device may be containers, and other computing devices may be computing devices (or groups of computing devices).

Although FIG. 1 shows that the AMD system 104 executes in a cloud-like configuration, in that it sits outside of the geographic zones 101, 103 and is communicatively coupled to the vehicles 102 of the geographic zones 101, 103 via a communication network 120, the AMD system 104 may be implemented in other arrangements. That is, in some embodiments, the AMD system 104 may be mounted (e.g., attached) on or inside a vehicle 102, such as an automotive vehicle, a marine vehicle, a railed vehicle, or an aircraft vehicle.

Still referring to FIG. 1, the AMD agent 111 receives, from a vehicle (e.g., vehicle 102a) in geographic zone 101, a geographic zone profile indicating that the vehicle 102a has generated a pattern-matching rule (e.g., YARA rule) which has been used to identify a type of malware that has infected the vehicle 102a and one or more neighboring vehicles (e.g., vehicles 102a, 102c) that are communicatively coupled to the vehicle 102a. The geographic zone profile includes the YARA rule and a malware identifier (ID) to the particular type of malware that was identified using the YARA rule. The message also includes one or more impact flags that are respectively associated with the one or more neighboring vehicles (e.g., vehicles 102a, 102c), where each impact flag indicates whether the malware does or does not infect the corresponding neighboring vehicles. The AMD agent 111 forwards the message to the YARA rule manager 109.

The YARA rule manager 109 uses its issue validator 110 to determine whether the type of malware is more of a local issue or a universal issue. Specifically, the issue validator 110 predicts whether the type of malware that has infected vehicle 102a has a low likelihood of spreading to other vehicles because it is a local issue or a high likelihood of spreading to other vehicles 102 because it is a universal issue. If the malware has a high likelihood of spreading, then the YARA rule manager 109 may decide to forward the geographic zone profile to the remedy generator 106; otherwise, the YARA rule manager 109 may decide that the likelihood is too low to forward the geographic zone profile to the remedy generator 106.

For example, a manufacturer of vehicle 102a might have approved a particular configuration for ECU 105a of vehicle 102a. However, the operator of vehicle 102a might have modified (e.g., altered) the manufacturer-approved configuration of ECU 105a such that it becomes more vulnerable to being infected with malware. In this situation, the issue validator 110 might determine that the type of malware infecting ECU 105a has a low likelihood of spreading to other vehicles because no (or very few) other vehicles 102 have ECUs 105 with the same modified-configuration, and therefore, decide to not forward the geographic zone profile to the remedy generator 106. Conversely, if the type of malware has shown to infect ECUs 105a operating in the manufacturer-approved configuration, then the issue validator 110 might determine that the type of malware infecting ECU 105a has a high likelihood of spreading to other vehicles.

The remedy generator 106 may generate, based on the geographic zone profile, a particular remedy for protecting a vehicle’s ECU 105 from being infected or cleaning a vehicle’s ECU 105 if it is already infected with the malware. In some embodiments, the remedy may be a software patch that, once installed on an ECU, protects vulnerable components of the ECU that are targeted by the malware. Alternatively, the software patch might be able to disarm or remove a malware from an ECU 105 that is already infected. In other embodiments, the remedy may be a warning for vehicles in other geographic zones to stay away from those geographic zones (e.g., geographic zone 101) known to include infected vehicles 102. The remedy generator 106 generates a remedy message that includes the remedy (e.g., software patch, warning) and sends it to the AMD agent 111, which in turn, sends the remedy message to any of the vehicles in geographic zone 1 and/or geographic zone 2.

Although FIG. 1 shows only a select number of computing devices (e.g., AMD system 104, ECUs 105) and vehicles 102; the environment 100 may include any number of computing devices and vehicles that are interconnected in any arrangement to facilitate the exchange of data between the computing devices.

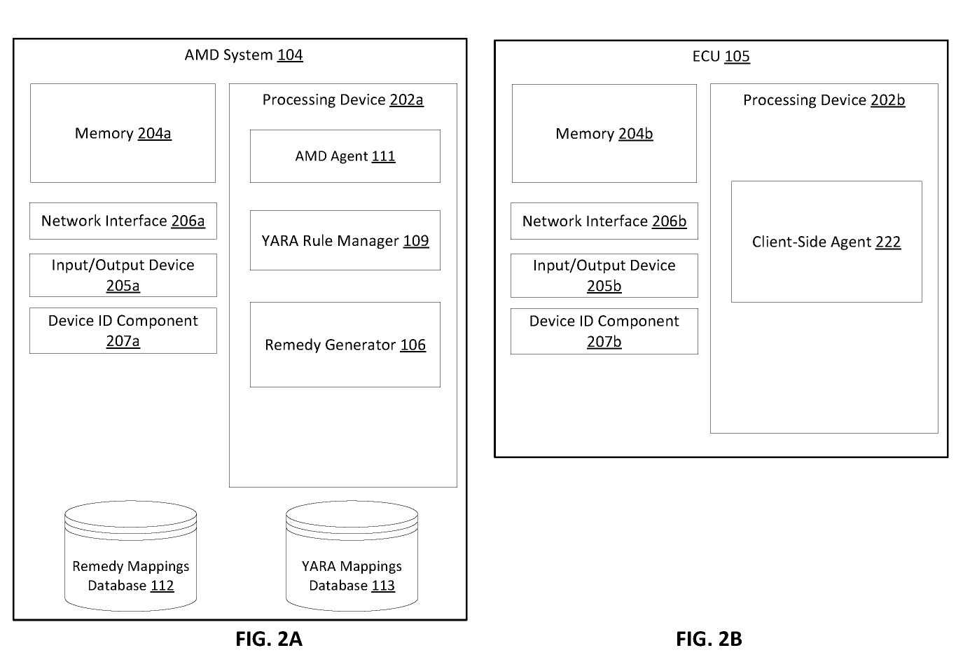

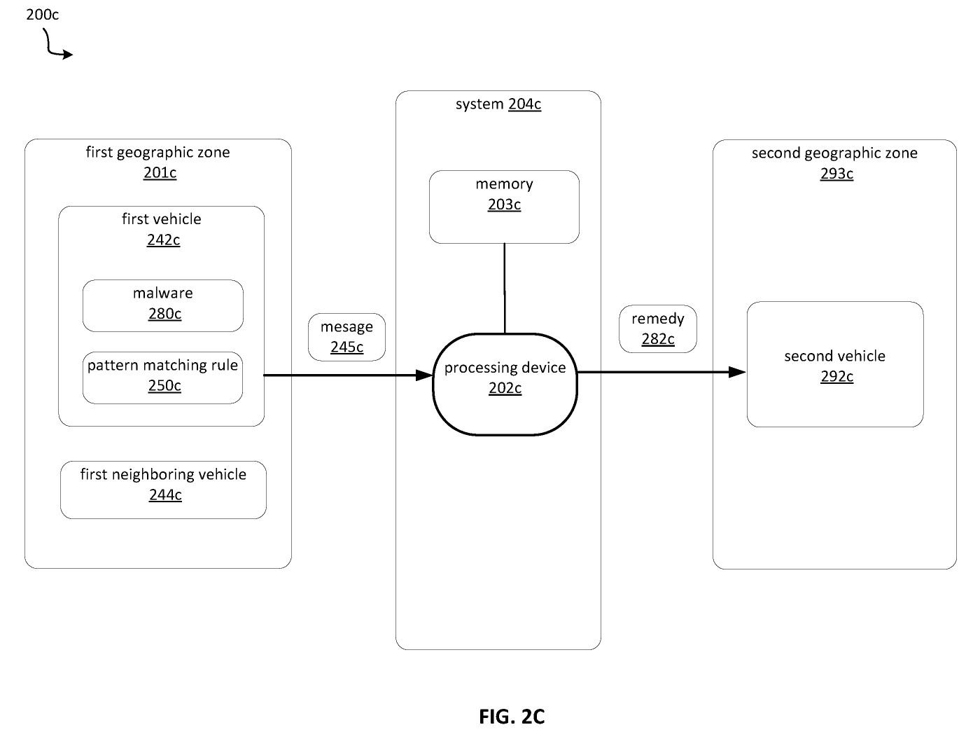

FIG. 2A is a block diagram depicting an example of the automotive malware diagnosis (AMD) system of the environment in FIG. 1, according to some embodiments. While various devices, interfaces, and logic with particular functionality are shown, it should be understood that the AMD system 104 includes any number of devices and/or components, interfaces, and logic for facilitating the functions described herein. For example, the activities of multiple devices may be combined as a single device and implemented on a same processing device (e.g., processing device 202a), as additional devices and/or components with additional functionality are included.

The AMD system 104 includes a processing device 202a (e.g., general purpose processor, a PLD, etc.), which may be composed of one or more processors, and a memory 204a (e.g., synchronous dynamic random-access memory (DRAM), read-only memory (ROM)), which may communicate with each other via a bus (not shown).

The processing device 202a may be provided by one or more general-purpose processing devices such as a microprocessor, central processing unit, or the like. In some embodiments, processing device 202a may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the processing device 202a may include one or more special-purpose processing devices such as an application specific integrated circuit (ASIC), a field programmable gate array (FPGA), a digital signal processor (DSP), network processor, or the like. The processing device 202a may be configured to execute the operations described herein, in accordance with one or more aspects of the present disclosure, for performing the operations and steps discussed herein.

The memory 204a (e.g., Random Access Memory (RAM), Read-Only Memory (ROM), Non-volatile RAM (NVRAM), Flash Memory, hard disk storage, optical media, etc.) of processing device 202a stores data and/or computer instructions/code for facilitating at least some of the various processes described herein. The memory 204a includes tangible, non-transient volatile memory, or non-volatile memory. The memory 204a stores programming logic (e.g., instructions/code) that, when executed by the processing device 202a, controls the operations of the AMD system 104. In some embodiments, the processing device 202a and the memory 204a form various processing devices and/or circuits described with respect to the AMD system 104. The instructions include code from any suitable computer programming language such as, but not limited to, C, C++, C#, Java, JavaScript, VBScript, Perl, HTML, XML, Python, TCL, and Basic.

The processing device 202a executes and/or includes AMD agent 111, a remedy generator 106, a YARA rule manager 109. The AMD system 104 includes a remedy mappings database 112, YARA mappings database 113.

The AMD agent 111 may be configured to receive, from a vehicle (e.g., vehicle 102a) in geographic zone 101, a geographic zone profile indicating that the vehicle 102a has generated a pattern-matching rule (e.g., YARA rule) which has been used to identify a type of malware on the vehicle 102a and one or more neighboring vehicles (e.g., vehicles 102a, 102c) that are communicatively coupled to the vehicle 102a. The geographic zone profile includes the YARA rule, a malware identifier (ID) to the malware identified using the YARA rule, and/or the malware itself. The geographic zone profile also includes one or more impact flags that are respectively associated with one or more neighboring vehicles (e.g., vehicles 102a, 102c) to the vehicle 102a, where each impact flag indicates whether the malware does or does not infect the corresponding neighboring vehicles 102. The AMD agent 111 may be configured to forward the geographic zone profile to the YARA rule manager 109.

The YARA rule manager 109 may be configured to generate a YARA mapping that associates (e.g., links) the YARA rule with the malware ID and store the YARA mapping in the YARA mappings database 113. For example, the YARA rule manager 109 may generate the YARA mapping by creating a schema (e.g., a table) that associates the YARA rule with the malware ID. The YARA rule manager 109 may repeat this process for each message it receives from any of the vehicles 102 in either of the geographic zones 101, 103.

The YARA rule manager 109 may be configured to use its issue validator 110 to determine whether the type of malware is a local issue or a universal issue. Specifically, the issue validator 110 predicts whether the type of malware that has infected vehicle 102a has a low likelihood of spreading to other vehicles (a local issue) or high likelihood of spreading to other vehicles 102 (a universal issue). If the malware is a universal issue, the YARA rule manager 109 may determine to forward the geographic profile to the remedy generator 106. Otherwise, the YARA rule manager 109 may decide to not forward the geographic profile to the remedy generator 106 if the malware is a local issue.

The remedy generator 106 may be configured to generate a remedy to protect vehicles from being infected with the type of malware. The AMD system 104 may be configured to protect a second vehicle (e.g., vehicle 102d) in a second geographic zone (e.g., geographic zone 103) from being infected with the type of malware by sending the remedy to the second vehicle to cause the second vehicle to implement the remedy. In some embodiments, the remedy includes at least one of a software patch to resolve the type of malware, a software patch to prevent a vehicle from being infected with the malware, and/or a warning to avoid a geographic zone that is known to include vehicles 102 infected with malware.

The YARA rule manager 109 may be configured to receive from a first set of vehicles in a first geographic zone (e.g., geographic zone 101) a first set of pattern-matching rules respectively associated with a first set of malware identifiers IDs. The YARA rule manager 109 may be configured to receive from a second set of vehicles in a second geographic zone (e.g., geographic zone 103) a second set of pattern-matching rules respectively associated with a second set of malware IDs. The YARA rule manager 109 may be configured to store in the YARA mappings database 113, the first set of malware IDs and the second set of malware IDs.

The remedy generator 106 may be configured to generate a first set of remedies respectively associated with the first set of malware IDs and generate a second set of remedies respectively associated with the second set of malware IDs. The remedy generator 106 may be configured to store, in the remedy mappings database 112, the first set of remedies and the second set of remedies.

In some embodiments, the first vehicle (e.g., vehicle 102a) transmitted the pattern-matching rule to the first neighboring vehicle (e.g., vehicle 102b) using a wireless communication protocol to cause the first neighboring vehicle to determine, using the pattern-matching rule, that a resource (e.g., memory, processor, storage, software drive, software application, operating system) of the first neighboring vehicle is infected with the type of malware.

In some embodiments, a pattern-matching rule make include at least one of a Yet Another Recursive Acronym (YARA) rule, a Sigma Rule, or a Suricata Rule, a Claim Antivirus (ClamAV) Signature, or Open Indicators of Compromise (OpenIOC) Rules.

In some embodiments, the geographic zone profile includes a first profile indicating a first set of resources on the first vehicle (e.g., vehicle 102a) and a second profile indicating a second set of resources on the second vehicle (e.g., vehicle 102b).

In some embodiments, the geographic zone profile may indicate that the first vehicle (e.g., vehicle 102a) corresponds to a particular type of vehicle. For example, the geographic zone profile indicates that the first vehicle is associated with a particular manufacturer, brand, vehicle class, manufacture year, ECU version, and/or the like. In this embodiment, the AMD agent 111 may be configured to identify a third geographic zone including a third vehicle corresponding to the particular type of vehicle (e.g. a truck) and a fourth vehicle corresponding to a different type of vehicle (e.g., a motorcycle), send the remedy to the third vehicle to cause the third vehicle to implement the remedy; and abstain from sending the remedy to the fourth vehicle.

In some embodiments, the AMD agent 111 may be configured to receive, from the first vehicle (e.g., vehicle 102a) in the first geographic zone (e.g., geographic zone 101), a second message indicating that a second pattern-matching rule has identified a second type of malware on the first vehicle, predict a likelihood for the second type of malware to spread to other vehicles, classify the likelihood as a low likelihood or a high likelihood, and either generate a second remedy to protect the other vehicles from being infected with the second type of malware responsive to classifying the likelihood as the high likelihood, or abstain from generating one or more remedies to protect the other vehicles from being infected with the second type of malware responsive to classifying the likelihood as the low likelihood.

The AMD system 104 includes a network interface 206a configured to establish a communication session with a computing device for sending and receiving data over the communication network 120 to the computing device. Accordingly, the network interface 206a includes a cellular transceiver (supporting cellular standards), a local wireless network transceiver (supporting 802.11X, ZigBee, Bluetooth, Wi-Fi, or the like), a wired network interface, a combination thereof (e.g., both a cellular transceiver and a Bluetooth transceiver), and/or the like. In some embodiments, the AMD system 104 includes a plurality of network interfaces 206a of different types, allowing for connections to a variety of networks, such as local area networks (public or private) or wide area networks including the Internet, via different sub-networks.

The AMD system 104 includes an input/output device 205a configured to receive user input from and provide information to a user. In this regard, the input/output device 205a is structured to exchange data, communications, instructions, etc. with an input/output component of the AMD system 104. Accordingly, input/output device 205a may be any electronic device that conveys data to a user by generating sensory information (e.g., a visualization on a display, one or more sounds, tactile feedback, etc.) and/or converts received sensory information from a user into electronic signals (e.g., a keyboard, a mouse, a pointing device, a touch screen display, a microphone, etc.). The one or more user interfaces may be internal to the housing of the AMD system 104, such as a built-in display, touch screen, microphone, etc., or external to the housing of AMD system 104, such as a monitor connected to AMD system 104, a speaker connected to AMD system 104, etc., according to various embodiments. In some embodiments, the AMD system 104 includes communication circuitry for facilitating the exchange of data, values, messages, and the like between the input/output device 205a and the components of the AMD system 104. In some embodiments, the input/output device 205a includes machine-readable media for facilitating the exchange of information between the input/output device 205a and the components of the AMD system 104. In still another embodiment, the input/output device 205a includes any combination of hardware components (e.g., a touchscreen), communication circuitry, and machine-readable media.

The AMD system 104 includes a device identification component 207a (shown in FIG. 2A as device ID component 207a) configured to generate and/or manage a device identifier associated with the AMD system 104. The device identifier may include any type and form of identification used to distinguish the AMD system 104 from other computing devices. In some embodiments, to preserve privacy, the device identifier may be cryptographically generated, encrypted, or otherwise obfuscated by any device and/or component of AMD system 104. In some embodiments, the AMD system 104 may include the device identifier in any communication (e.g., remedy message, etc.) that the AMD system 104 sends to a computing device.

The AMD system 104 includes a bus (not shown), such as an address/data bus or other communication mechanism for communicating information, which interconnects the devices and/or components of AMD system 104, such as processing device 202a, network interface 206a, input/output device 205a, and device ID component 207a.

In some embodiments, some or all of the devices and/or components of AMD system 104 may be implemented with the processing device 202a. For example, the AMD system 104 may be implemented as a software application stored within the memory 204a and executed by the processing device 202a. Accordingly, such embodiment can be implemented with minimal or no additional hardware costs. In some embodiments, any of these above-recited devices and/or components rely on dedicated hardware specifically configured for performing operations of the devices and/or components.

FIG. 2B is a block diagram depicting an example of the electronic control unit in FIG. 1, according to some embodiments. While various devices, interfaces, and logic with particular functionality are shown, it should be understood that the electronic control unit 105 includes any number of devices and/or components, interfaces, and logic for facilitating the functions described herein. For example, the activities of multiple devices may be combined as a single device and implemented on a same processing device (e.g., processing device 202b), as additional devices and/or components with additional functionality are included.

The electronic control unit 105 includes a processing device 202b (e.g., general purpose processor, a PLD, etc.), which may be composed of one or more processors, and a memory 204b (e.g., synchronous dynamic random-access memory (DRAM), read-only memory (ROM)), which may communicate with each other via a bus (not shown). The processing device 202b includes identical or nearly identical functionality as processing device 202a in FIG. 2A, but with respect to devices and/or components of the electronic control unit 105 instead of devices and/or components of the AMD system 104.

The memory 204b of processing device 204b stores data and/or computer instructions/code for facilitating at least some of the various processes described herein. The memory 204b includes identical or nearly identical functionality as memory 204a in FIG. 2A, but with respect to devices and/or components of the electronic control unit 105 instead of devices and/or components of the AMD system 104.

The processing device 202b may be configured to execute a client-side agent 222 that sends a geographic zone profile to the AMD system 104, where the geographic zone profile indicates that a pattern-matching rule has identified a type of malware on the electronic control unit 105 of the vehicle 102 and a neighboring vehicle communicatively coupled to the vehicle 102. The client-side agent 222 may be configured to receive, from the AMD system 104, a message that includes a remedy. If the client-side agent 222 determines that the remedy is a software patch, then the client-side agent 222 may install the software patch on its corresponding ECU 105 to protect the ECU from the malware. If the client-side agent 222 determines that the remedy is a warning to avoid a particular geographic zone (e.g., geographic zone 101), then the client-side agent 222 can control components (e.g., steering, breaking, acceleration) of the vehicle 102 to keep the vehicle from entering the geographic zone. In some embodiments, the client-side agent 222 can display the warning on a screen inside the vehicle 102 to notify the driver about the geographic zones that include vehicles infected with malware.

The electronic control unit 105 includes a network interface 206b configured to establish a communication session with a computing device for sending and receiving data over a network to the computing device. Accordingly, the network interface 206b includes identical or nearly identical functionality as network interface 206a in FIG. 2A, but with respect to devices and/or components of the electronic control unit 105 instead of devices and/or components of the AMD system 104.

The electronic control unit 105 includes an input/output device 205b configured to receive user input from and provide information to a user. In this regard, the input/output device 205b is structured to exchange data, communications, instructions, etc. with an input/output component of the electronic control unit 105. The input/output device 205b includes identical or nearly identical functionality as input/output device 205a in FIG. 2A, but with respect to devices and/or components of the electronic control unit 105 instead of devices and/or components of the AMD system 104.

The electronic control unit 105 includes a device identification component 207b (shown in FIG. 2B as device ID component 207b) configured to generate and/or manage a device identifier associated with the electronic control unit 105. The device ID component 207b includes identical or nearly identical functionality as device ID component 207a in FIG. 2A, but with respect to devices and/or components of the electronic control unit 105 instead of devices and/or components of the AMD system 104.

The electronic control unit 105 includes a bus (not shown), such as an address/data bus or other communication mechanism for communicating information, which interconnects the devices and/or components of the electronic control unit 105, such as processing device 202b, network interface 206b, input/output device 205b, and device ID component 207b.

In some embodiments, some or all of the devices and/or components of electronic control unit 105 may be implemented with the processing device 202b. For example, the electronic control unit 105 may be implemented as a software application stored within the memory 204b and executed by the processing device 202b. Accordingly, such embodiment can be implemented with minimal or no additional hardware costs. In some embodiments, any of these above-recited devices and/or components rely on dedicated hardware specifically configured for performing operations of the devices and/or components.

FIG. 2C is a block diagram depicting an example environment for using the AMD system in FIG. 1, according to some embodiments. The system 204c (e.g., AMD system 104 in FIG. 1) includes a memory 203c and a processing device 202c that is operatively coupled to the memory 203c. The processing device 202c is configured to receive, from a first vehicle 242c in a first geographic zone 201c, a message 245c indicating that a pattern-matching rule 250c has identified a type of malware 280c on the first vehicle 242c and a first neighboring vehicle 244c communicatively coupled to the first vehicle 242c and within the first geographic zone 201c. The processing device 202c is configured to generate a remedy 282c to protect vehicles from being infected with the type of malware 280c. The processing device 202c is configured to protect a second vehicle 292c in a second geographic zone 293c from being infected with the type of malware 280c by sending the remedy 282c to the second vehicle 292c to cause the second vehicle 292c to implement the remedy 282c.

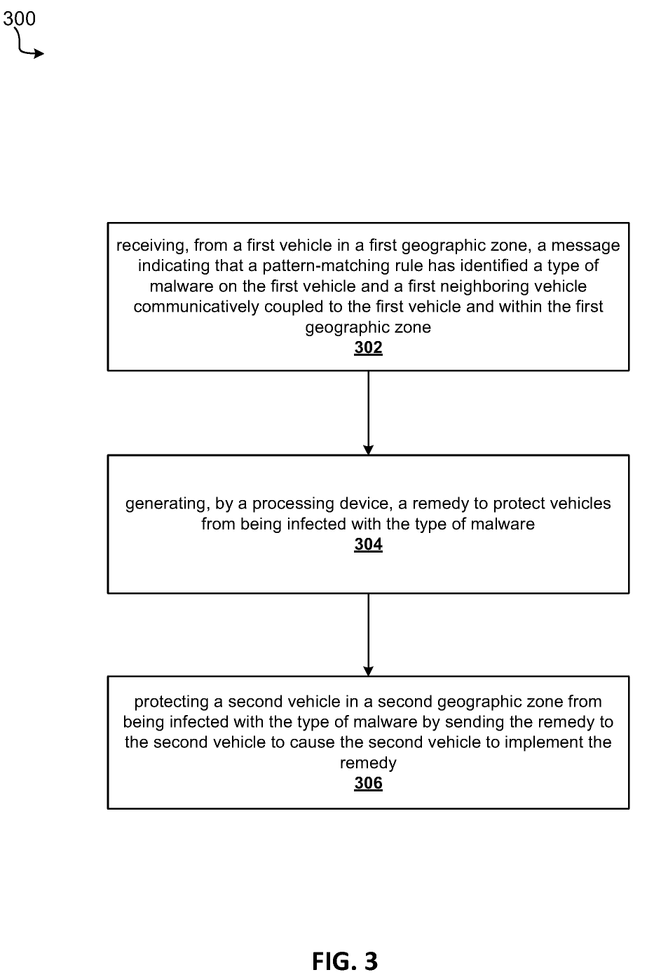

FIG. 3 is a flow diagram depicting a method of detecting and mitigating the spread of malware in vehicle-to-vehicle networks, according to some embodiments. Method 300 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, one or more blocks of method 300 may be performed by one or more automotive malware diagnosis system, such as AMD system 104 in FIG. 1.

With reference to FIG. 3, method 300 illustrates example functions used by various embodiments. Although specific function blocks ("blocks") are disclosed in method 300, such blocks are examples. That is, embodiments are well suited to performing various other blocks or variations of the blocks recited in method 300. It is appreciated that the blocks in method 300 may be performed in an order different than presented, and that not all of the blocks in method 300 may be performed.

As shown in FIG. 3, the method 300 includes the block 302 of receiving, from a first vehicle in a first geographic zone, a message indicating that a pattern-matching rule has identified a type of malware on the first vehicle and a first neighboring vehicle communicatively coupled to the first vehicle and within the first geographic zone. The method 300 includes the block 304 of generating a remedy to protect vehicles from being infected with the type of malware. The method 300 includes the block 306 of protecting a second vehicle in a second geographic zone from being infected with the type of malware by sending the remedy to the second vehicle to cause the second vehicle to implement the remedy.

As shown in FIG. 3, the method 300 includes the block 302 of receiving a request for information indicating an updatability of a plurality of software applications executing on a plurality of client devices to a particular version. The method 300 includes the block 304 of predicting a plurality of issues associated with an update of the plurality of software applications to the particular version prior to performing the update. The method 300 includes the block 306 of classifying the plurality of issues into a plurality of issue groups. The method 300 includes the block 308 of generating a plurality of scores respectively associated with the plurality of issue groups. The method 300 includes the block 310 of ranking the plurality of issue groups based on the plurality of scores.

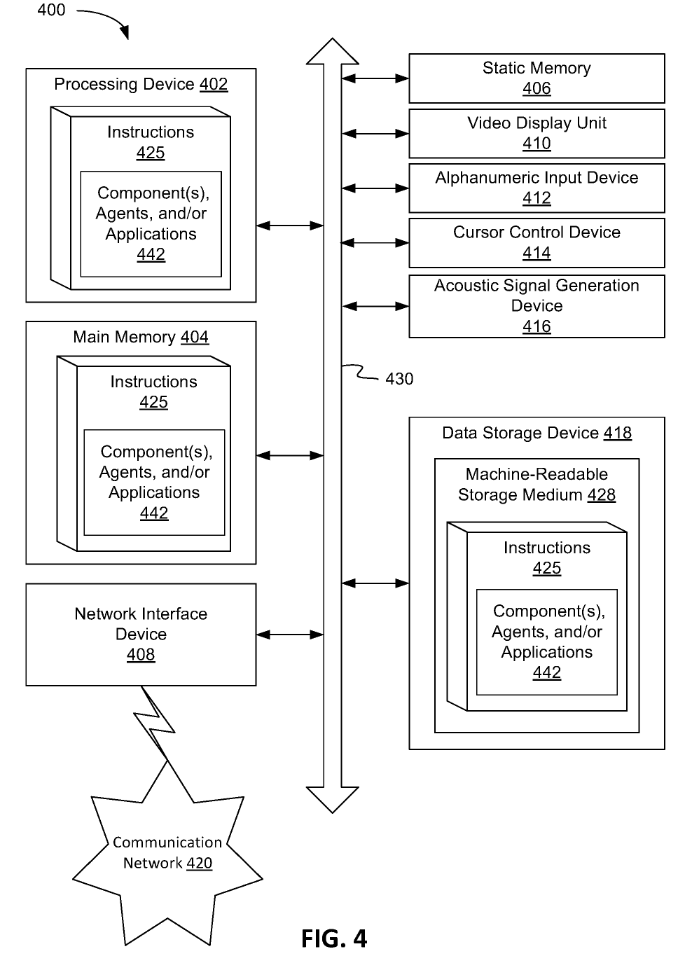

FIG. 4 is a block diagram of an example computing device that may perform one or more of the operations described herein, in accordance with some embodiments. Computing device 400 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term "computing device" shall also be taken to include any collection of computing devices that individually or jointly execute a set (or multiple sets) of instructions to perform the methods discussed herein.

The example computing device 400 may include a processing device (e.g., a general-purpose processor, a PLD, etc.) 402, a main memory 404 (e.g., synchronous dynamic random-access memory (DRAM), read-only memory (ROM)), a static memory 406 (e.g., flash memory and a data storage device 418), which may communicate with each other via a bus 430.

Processing device 402 may be provided by one or more general-purpose processing devices such as a microprocessor, central processing unit, or the like. In an illustrative example, processing device 402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 402 may also include one or more special-purpose processing devices such as an application specific integrated circuit (ASIC), a field programmable gate array (FPGA), a digital signal processor (DSP), network processor, or the like. The processing device 402 may be configured to execute the operations described herein, in accordance with one or more aspects of the present disclosure, for performing the operations and steps discussed herein.

Computing device 400 may further include a network interface device 408 which may communicate with a communication network 420. The computing device 400 also may include a video display unit 410 (e.g., a liquid crystal display (LCD) or a cathode ray tube (CRT)), an alphanumeric input device 412 (e.g., a keyboard), a cursor control device 414 (e.g., a mouse) and an acoustic signal generation device 416 (e.g., a speaker). In one embodiment, video display unit 410, alphanumeric input device 412, and cursor control device 414 may be combined into a single component or device (e.g., an LCD touch screen).

Data storage device 418 may include a computer-readable storage medium 428 on which may be stored one or more sets of instructions 425 that may include instructions for one or more components/programs/applications 442 (e.g., remedy message, etc.) for carrying out the operations described herein, in accordance with one or more aspects of the present disclosure. Instructions 425 may also reside, completely or at least partially, within main memory 404 and/or within processing device 402 during execution thereof by computing device 400, main memory 404 and processing device 402 also constituting computer-readable media. The instructions 425 may further be transmitted or received over a communication network 420 via network interface device 408.

While computer-readable storage medium 428 is shown in an illustrative example to be a single medium, the term "computer-readable storage medium" should be taken to include a single medium or multiple media (e.g., a centralized or distributed database and/or associated caches and servers) that store the one or more sets of instructions. The term "computer-readable storage medium" shall also be taken to include any medium that is capable of storing, encoding or carrying a set of instructions for execution by the machine and that cause the machine to perform the methods described herein. The term "computer-readable storage medium" shall accordingly be taken to include, but not be limited to, solid-state memories, optical media and magnetic media.

Unless specifically stated otherwise, terms such as "receiving," "generating," "protecting," "storing," "identifying," "sending," "abstaining," "predicting," "determining," "classifying," or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms "first," "second," "third," "fourth," etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware--for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112(f), for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present embodiments to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present embodiments are not to be limited to the details given herein, but may be modified within the scope and equivalents of the appended claims.

What is claimed is:

1. A method of comprising:
receiving, from a first vehicle in a first geographic zone, a message indicating that a pattern-matching rule has identified a type of malware on the first vehicle and a first neighboring vehicle communicatively coupled to the first vehicle and within the first geographic zone;
generating, by a processing device, a remedy to protect vehicles from being infected with the type of malware; and
sending the remedy to a second vehicle in a second geographic zone to cause the second vehicle to implement the remedy.

2. The method of claim 1, wherein the remedy comprises at least one of a software patch to resolve the type of malware or a warning to avoid the first geographic zone.

3. The method of claim 1, wherein the first vehicle detected the type of malware on the first vehicle and generated the pattern-matching rule based on the type of malware responsive to detecting the type of malware on the first vehicle.

4. The method of claim 1, further comprising:
receiving from a first set of vehicles in the first geographic zone a first set of pattern-matching rules respectively associated with a first set of malware identifiers (IDs);
receiving from a second set of vehicles in the second geographic zone a second set of pattern-matching rules respectively associated with a second set of malware IDs;
storing, in one or more databases, the first set of malware IDs and the second set of malware IDs.

5. The method of claim 4, further comprising:
generating a first set of remedies respectively associated with the first set of malware IDs;
generating a second set of remedies respectively associated with the second set of malware IDs; and
storing, in the one or more databases, the first set of remedies and the second set of remedies.

6. The method of claim 1, wherein the first vehicle transmitted the pattern-matching rule to the first neighboring vehicle using a wireless communication protocol to cause the first neighboring vehicle to determine, using the pattern-matching rule, that a resource of the first neighboring vehicle is infected with the type of malware.

7. The method of claim 1, wherein the pattern-matching rule comprises at least one of a Yet Another Recursive Acronym (YARA) rule, a Sigma Rule, or a Suricata Rule, a Claim Antivirus (ClamAV) Signature, or Open Indicators of Compromise (OpenIOC) Rules.

8. The method of claim 1, wherein the message comprises a first profile indicating a first set of resources on the first vehicle and a second profile indicating a second set of resources on the second vehicle.

9. The method of claim 1, wherein the message indicates that the first vehicle corresponds to a particular type of vehicle, and further comprising:
identifying a third geographic zone comprising a third vehicle corresponding to the particular type of vehicle and a fourth vehicle corresponding to a different type of vehicle;
sending the remedy to the third vehicle to cause the third vehicle to implement the remedy; and
abstaining from sending the remedy to the fourth vehicle.

10. The method of claim 1, further comprising:
receiving, from the first vehicle in the first geographic zone, a second message indicating that a second pattern-matching rule has identified a second type of malware on the first vehicle;
predicting a likelihood for the second type of malware to spread to other vehicles;
classifying the likelihood as a low likelihood or a high likelihood, and either:
generating a second remedy to protect the other vehicles from being infected with the second type of malware responsive to classifying the likelihood as the high likelihood, or
abstaining from generating one or more remedies to protect the other vehicles from being infected with the second type of malware responsive to classifying the likelihood as the low likelihood.

11. A system comprising:
a memory; and
a processing device, operatively coupled to the memory, to:
receive, from a first vehicle in a first geographic zone, a message indicating that a pattern-matching rule has identified a type of malware on the first vehicle and a first neighboring vehicle communicatively coupled to the first vehicle and within the first geographic zone;
generate a remedy to protect vehicles from being infected with the type of malware; and
send the remedy to a second vehicle in a second geographic zone to cause the second vehicle to implement the remedy.

12. The system of claim 11, wherein the remedy comprises at least one of a software patch to resolve the type of malware or a warning to avoid the first geographic zone.

13. The system of claim 11, wherein the first vehicle detected the type of malware on the first vehicle and generated the pattern-matching rule based on the type of malware responsive to detecting the type of malware on the first vehicle.

14. The system of claim 11, wherein the processing device is further to:
receive from a first set of vehicles in the first geographic zone a first set of pattern-matching rules respectively associated with a first set of malware identifiers (IDs);
receive from a second set of vehicles in the second geographic zone a second set of pattern-matching rules respectively associated with a second set of malware IDs; and
store, in one or more databases, the first set of malware IDs and the second set of malware IDs.

15. The system of claim 11, wherein the processing device is further to:
generate a first set of remedies respectively associated with the first set of malware IDs;
generate a second set of remedies respectively associated with the second set of malware IDs; and
store, in the one or more databases, the first set of remedies and the second set of remedies.

16. The system of claim 11, wherein the first vehicle transmitted the pattern-matching rule to the first neighboring vehicle using a wireless communication protocol to cause the first neighboring vehicle to determine, using the pattern-matching rule, that a resource of the first neighboring vehicle is infected with the type of malware.

17. The system of claim 11, wherein the pattern-matching rule comprises at least one of a Yet Another Recursive Acronym (YARA) rule, a Sigma Rule, or a Suricata Rule, a Claim Antivirus (ClamAV) Signature, or Open Indicators of Compromise (OpenIOC) Rules.

18. The system of claim 11, wherein the message comprises a first profile indicating a first set of resources on the first vehicle and a second profile indicating a second set of resources on the second vehicle.

19. The system of claim 11, wherein the message indicates that the first vehicle corresponds to a particular type of vehicle, and wherein the processing device is further to:
identify a third geographic zone comprising a third vehicle corresponding to the particular type of vehicle and a fourth vehicle corresponding to a different type of vehicle;
send the remedy to the third vehicle to cause the third vehicle to implement the remedy; and
abstain from sending the remedy to the fourth vehicle.

20. A non-transitory computer-readable medium storing instructions that, when executed by a processing device, cause the processing device to:
receive, from a first vehicle in a first geographic zone, a message indicating that a pattern-matching rule has identified a type of malware on the first vehicle and a first neighboring vehicle communicatively coupled to the first vehicle and within the first geographic zone;
generate, by the processing device, a remedy to protect vehicles from being infected with the type of malware; and
send the remedy to a second vehicle in a second geographic zone to cause the second vehicle to implement the remedy.
